(19) United States
(12) Patent Application Publication
(10) Pub. No.: US 2021/0103035 A1
(43) Pub. Date: Apr. 8, 2021

(54) Optoelectronic Sensor and Method of Detecting Objects

(71) Applicant: SICK AG, Waldkirch (DE)

(72) Inventor: Thomas RUSS, Waldkirch (DE)

(21) Appl. No.: 17/065,427

(22) Filed: Oct. 7, 2020

(30) Foreign Application Priority Data
Oct. 8, 2019 (DE) 102019126982.2

(51) Int. Cl. G01S 7/481; G01S 17/89

(52) U.S. Cl. CPC G01S 7/4812; G01S 7/4813; G01S 17/89

(57) ABSTRACT

An optoelectronic sensor for detecting objects in a monitored zone is provided that has at least one light transmitter for transmitting a plurality of mutually separated light beams, a transmission optics for the transmitted light beams, at least one light receiver for generating a respective reception signal from light beams remitted by objects, a reception optics for the remitted light beams, and a control and evaluation unit for obtaining information on the objects from the reception signals, wherein the transmission optics and/or the reception optics has/have a first optical system. In this respect, the transmission optics and/or the reception optics has/have a second optical system for correcting aberrations comprising a plurality of optical correction elements that are each associated with a light beam and the second optical system is arranged between a beam separation plane.

The invention relates to an optoelectronic sensor for detecting objects in a monitored zone that has at least one light transmitter for transmitting a plurality of mutually separated light beams, a transmission optics for the transmitted light beams, at least one light receiver for generating a respective reception signal from light beams remitted by objects, a reception optics for the remitted light beams, and a control and evaluation unit for obtaining information on the objects from the reception signals, wherein the transmission optics and/or the reception optics has/have a first optical system, and to a method of detecting objects in a monitored zone in which a plurality of mutually separated light beams are transmitted by a light transmitter through a transmission optics, a respective reception signal is generated in a light receiver from the light beams reflected by objects after a passing through of a reception optics, and the reception signals are evaluated to obtain information on the objects, wherein the transmission optics and/or the reception optics has/have a first optical system.

Many optoelectronic sensors work in accordance with the scanning principle in which a light beam is transmitted into the monitored zone and the light beam reflected by objects is received again in order to then electronically evaluate the reception signal. The time of flight is in this respect often measured using a known phase method or pulse method to determine the distance of a sensed object.

To extend the measuring zone of a single-beam light scanner, the scanning beam can be moved, on the one hand, as is the case in a laser scanner. A light beam generated by a laser there periodically sweeps over the monitored zone with the aid of a deflection unit. In addition to the measured distance information, the angular location of the object is concluded from the angular position of the deflection unit and the location of an object in the monitored zone is thus detected in two-dimensional polar coordinates.

A further possibility for extending the measuring zone and for obtaining additional distance data comprises simultaneously detecting a plurality of measurement points by a plurality of scanning beams. This can also be combined with a laser scanner that then does not only detect a monitored plane, but also a three-dimensional spatial zone via a plurality of monitored planes. The scanning movement is achieved by a rotating mirror in most laser scanners. Particularly when a plurality of scanning beams are used, it is, however, also known in the prior art to instead have the total measurement head with the light transmitters and light receivers rotate as is, for example, described in DE 197 57 849 B4.

In principle, a plurality of scanning beams can be achieved by duplicating the components of a single-beam device. However, this is unnecessarily expensive and complex. Therefore, there are approaches in the prior art to use components several times. For example, in DE 10 2015 121 839 A1, the scanning beams of a plurality of light transmitters are shaped by a common transmission optics and deflected in the desired direction.

U.S. Pat. No. 8,767,190 B2 selects the approach of providing a separate light transmitter and light receiver for each scanning plane. Thus, there is then in principle the possibility of adjusting each individual scanning plane as desired. The system is indeed highly flexible, but only at the price of an enormous effort for the components and the respective individual adjustment.

It is now indeed desirable to use a common optics for a plurality of beams at the same time. However, contradictory demands are made on the optics in this respect. On the one hand, it should be as simple as possible for cost reasons, but, on the other hand, it should simultaneously sharply image all the beams in an image field that is as large as possible. A simple optics can be implemented with the aid of a single lens. However, under the given conditions of a sufficiently large aperture, only a small image field angular range is thus possible. Consequently, only scanning beams disposed closely together can be implemented with a single lens. With a sensible mutual distance of a few degrees, a single lens enables no more than two or three scanning beams. On the other hand, there is also the possibility of dispensing with a simple optics and using a multi-lens objective. Small dot images can thereby also be generated over a larger image field angle. However, this means a considerable effort for the manufacture and adjustment of a plurality of lenses.

EP 3 182 153 B1 proposes an additional degree of design freedom of the reception optics by a height structuring on the light receiver. However, this precludes the use of flat standard light receivers. In an embodiment, the height structure is achieved by means of a transparent stepped component. A similar solution is proposed in JP 2007/094168 A. However, not all the aberrations, in particular not astigmatism, can be compensated in this manner.

The still unpublished German patent application having the file reference 102018125826.7 uses a two-lens objective that is optimized for the imaging of a circular ring. However, it can only be used in a sensible manner under the restrictive condition that the light receivers are likewise arranged in circular form.

In addition to the imaging quality of the reception optics, the ratio of useful light to external light also plays an important role for a high-quality detection. This particularly applies to highly sensitive light receivers having the ability to detect single photons (SPAD, single photon avalanche photodiode, or SiPM, silicon photomultiplier). To improve this ratio, a discrete field of view can be defined at the reception side with the aid of an aperture array in the focal plane of the optics. The aperture openings correspond to the plurality of reception beams and the smaller their individual aperture diameters are without also shielding useful light, the better the ratio becomes.

To design the aperture diameter as small as possible, various parameters have to be considered such as adjustment accuracies, the angular extent of the light transmitter, thermal behavior, tolerances of the optomechanical system, and the nominal imaging quality of the optics. It has already been mentioned that the optics can only in a complex objective design achieve small spot diameters over a larger image field angle. A correspondingly complex and/or expensive optics is also required in front of the transmitter since angular errors at the transmission side lead to larger spots at the reception side and thus to aperture openings.

US 2017/0289524 A1 discloses an optical system for detecting distance information. A large reception lens having an aperture array is provided at the reception side. Due to the unavoidable aberrations of the reception lens, the aperture openings cannot become small. A microlens array is also provided behind the focal plane of the reception lens and the aperture array to collimate the beam path with an interference filter arranged downstream for a further suppression of external light. It is not the function of the microlenses and also could not be their function in this arrangement to improve the optical image in front of the aperture. The microlenses all have the same contour and are thus also not capable of correcting aberrations in their optical properties.

The still unpublished German patent application having the file reference 102018109544.9 describes various design possibilities for the arrangement and shape of apertures in a multi-beam system of the category by which external light can be efficiently reduced. However, the imaging of the reception optics in front of the apertures is not improved in this respect.

In the still unpublished German patent application having the file reference 102018118653.3, an additional light-scattering optical element of the reception optics is proposed by which the angle of incidence is reduced to a narrow-band filter. A narrower passband, which would shift with the angle of incidence, should thereby be made possible. This also does not improve the imaging of the reception optics itself.

DE 10 2017 129 100 A1 shows a further multi-beam laser scanner having a concentrator optics for bringing together the reception beams at the reception side. The problem of the imaging properties of the reception optics is thus also not solved.

A laser scanner is typically protected by a peripheral front screen or hood, for example in the form of a cylinder. The front screen distorts the beam path. To correct this, an expensive and/or complex biconical asphere is, for example, required. The still unpublished European application having the file reference 19158884.7 proposes to contour the rotating mirror of a laser scanner such that these distortions are compensated.

It is therefore the object of the invention to simplify and to improve a multi-beam system of the category.

This object is satisfied by an optoelectronic sensor and by a method of detecting objects in a monitored zone in accordance with the respective independent claim. The sensor in accordance with the invention is a multi-scanner that transmits a plurality of light beams by at least one light transmitter through a transmission optics. The transmitted light beams are not to be understood as beams in the sense of geometrical optics within a larger light bundle, but rather as mutually separated light beams and thus isolated scanning beams that generate correspondingly isolated, mutually spaced apart light spots in the monitored zone on incidence onto an object. The remitted light beams returning from the detection zone are guided by a reception optics to a light receiver that generates a respective reception signal from the remitted light beams. The reception signals generated in this way are evaluated to obtain information on the object. The transmission optics and/or reception optics has/have a first optical system. In the case of a common transmission-reception optics, it is the same optical system; otherwise, if both the transmission optics and the reception optics have a first optical system, a first optical system consequently results in each case.

The invention starts from the basic idea of using a second optical system in the transmission optics and/or the reception optics to correct aberrations of the first optical system. A plurality of optical correction elements associated with the light beams are provided therein, preferably one per light beam. The second optical system is arranged between the first optical system and the light transmitter or the light receiver, and indeed in a region from a beam separation plane in which the light beams do not mutually overlap. The beam separation plane is in parallel with the imaging plane of the first optical system and is disposed in front of the imaging plane. The order is therefore a first optical system, a beam separation plane, a second optical system, and a light transmitter or a light receiver, wherein the second optical system is preferably already arranged in or in any event as close as possible to the beam separation plane.

The invention has the advantage that an inexpensive, lightweight transmission optics and/or reception optics having very good optical properties becomes/become possible that specifically for the purpose of a multi-beam scanning system, having a field of view comprising discretely arranged field points, replaces/replace a complex and expensive objective. In contrast to the conventional objective, the second optical system in no way attempts to image the total field of view as free of error as possible, but only the part regions of the light beams that are discrete from the beam separation plane. Additional degrees of design freedom by which the relevant errors are reduced are thereby produced. The imaging properties in the field of view of the first optical system, which are not passed through by any light beams, would generally even be particularly poor due to the optimization, but this relates to unused field of view regions of the sensor.

The light beams are preferably arranged in one plane. The light beams are therefore disposed in one row or column. This is particularly suitable for a scanning movement transverse to this row that then scans the spatial zone in a screened manner in accordance with the beam spacing.

The first optical system preferably has at least one common lens. It is consequently a refractive first optical system. A common lens means that all the light beams pass through this lens.

The first optical system preferably has two lenses, in particular a spherical lens and an aspherical lens. The two lenses are preferably each plano-convex. With two lenses, at least some of the restrictions and aberrations of a single lens can be compensated. However, a high-quality objective can not yet be designed from two lenses. The sufficient imaging quality of the multi-beam sensor in accordance with the invention is only achieved in combination with the second optical element.

The first optical system is preferably optimized for a correction of coma and/or spherical aberration and the optimization allows a variation in the back focal length for an improved correction of coma and/or spherical aberration. A variation in the back focal length means an image field curvature that thus at least largely remains out of consideration or is even enlarged on the optimization of the first optical system. The individual light beams are not imaged in a common plane by the first optical system. In return, coma and spherical aberration, if necessary also chromatic aberrations, can be better compensated. The second optical system is then responsible for the image field curvature.

The optical correction elements of the second optical system are preferably configured as correction lenses. Thus, it is a case of a refractive second optical system and they are lenses that do not only have planar inlet and outlet surfaces. However, one of the sides, for example the rear side, may by all means remain planar.

The optical correction elements have optical properties that are different from one another. Thus, they are not optical correction elements or correction lenses of the same kind, but have differences from one another, for instance in the shape, in the arrangement with respect to the associated light beam, or in the material. Consequently, the second optical system would not have the same optical effect if optical correction elements were to exchange their positions with one another.

The optical correction elements are preferably individually optimized for the respective associated light beam. The correction elements are specifically adapted to the light beam associated with them. These optimizations are therefore decoupled from one another since the light beams are already isolated due to the position of the second optical system in or beyond the beam separation plane. Particularly good imaging properties are thereby achieved. The curvatures or functional surfaces of the optical correction plane preferably only relate to one surface, for example to the front side, while the oppositely disposed surface remains planar.

The optical correction elements are preferably arranged in a common correction plane in particular in parallel with the beam separation plane. This results in a compact arrangement and enables the optical correction elements to be easily combined and to be installed in an adjusted manner.

The second optical system is preferably configured as a common component of the optical correction elements. The respective optical correction elements are, for example, configured as a plurality of contours or functional surfaces. A very favorable manufacture, for example by injection molding or molding, is particularly possible as a plastic component where an effort for the specific shaping then only results for the tool.

The optical correction elements preferably have a free-form surface. A particularly large number of degrees of freedom results for the optimization. In the design of the second optical system as a common component, a free-form shape results overall that has respective regions or functional surfaces for the optical correction elements. A manufacture from plastic from one tool is again possible with particularly little effort.

The optical correction elements preferably have a non-symmetrical contour in the meridional plane of the first optical system. Thus, in contrast to typical lenses, the optical correction elements are also not rotationally symmetrical. If, in a preferred embodiment, the field points are disposed in one plane, this plane corresponds to the meridional plane. In contrast, the optical correction elements are preferably symmetrical in the sagittal plane.

The second optical system is preferably configured for a correction of image field curvature and/or of astigmatism. They are precisely those aberrations that are not sufficiently corrected in the first optical system or are specifically accepted and possibly even enlarged there. As already mentioned, the optimization preferably takes place individually and independently for the respective optical correction elements. Therefore, said aberrations can be compensated particularly effectively.

The sensor preferably has a curved front screen, wherein the second optical system is additionally configured for a correction of distortions, in particular of astigmatism, of the front screen. The front screen was briefly mentioned in the introduction. In particular in the case of a sensor configured as a laser scanner, said front screen typically, but not necessarily, has a rotationally symmetrical geometry, and is, for example, a cylinder, a truncated cone, a spherical segment, or a cup. In any case, it shows a curvature in the sagittal plane and the individual part beams in the light bundle of the respective transmitted light beams and returning remitted light beams thereby experience different deflections, wherein this effect is strongly astigmatic. These distortions through the front screen can additionally be taken into account in the design of the optical correction elements, in particular by compensating an astigmatism of the front screen in addition to the astigmatism of the first optical system. In the optical design, this is merely a change or an amplification of the aberrations that anyway are to be corrected. The manufacturing costs for the second optical element remain unaffected by this; the correction of the distortions of the front screen is achieved practically without any additional effort. At the same time, the correction is even better than with existing solutions since it can be applied to the individual light beams.

An aperture having a respective aperture opening per reception light beam is preferably arranged between the second optical system and the light receiver. From the point of view of the remitted light beams, the aperture is therefore located behind the second optical element. The aperture openings can therefore be particularly small since an almost point-like beam cross-section of all the remitted light beams in the same plane in parallel with the imaging plane is achieved by the second optical element. External light is thus particularly effectively suppressed.

The sensor is preferably configured as a laser scanner and has a movable deflection unit with whose aid the transmitted light beams are periodically guided through the monitored zone. As explained in the introduction, the laser scanner scans the monitored zone in a plurality of planes with the movement of the movable deflection unit. The deflection unit is preferably configured in the form of a rotatable scanning unit that practically forms a movable measurement head in which the light transmitter and/or the light receiver together with the reception optics and, if applicable, also at least parts of the evaluation unit is/are accommodated.

The evaluation unit is preferably configured to determine a distance of the objects from a time of flight between the transmission of the light beams and the reception of the remitted light beams. The sensor thereby becomes a distance-measuring multi-beam sensor or a laser scanner. Alternatively, only the presence of an object is determined and is, for example, output as a switching signal.

The method in accordance with the invention can be further developed in a similar manner and has similar advantages in this respect. Such advantageous features are described in an exemplary, but not exclusive, manner in the subordinate claims dependent on the independent claims.

The invention will also be explained in more detail in the following with respect to further features and advantages by way of example with reference to embodiments and to the enclosed drawing. The Figures of the drawings show in:

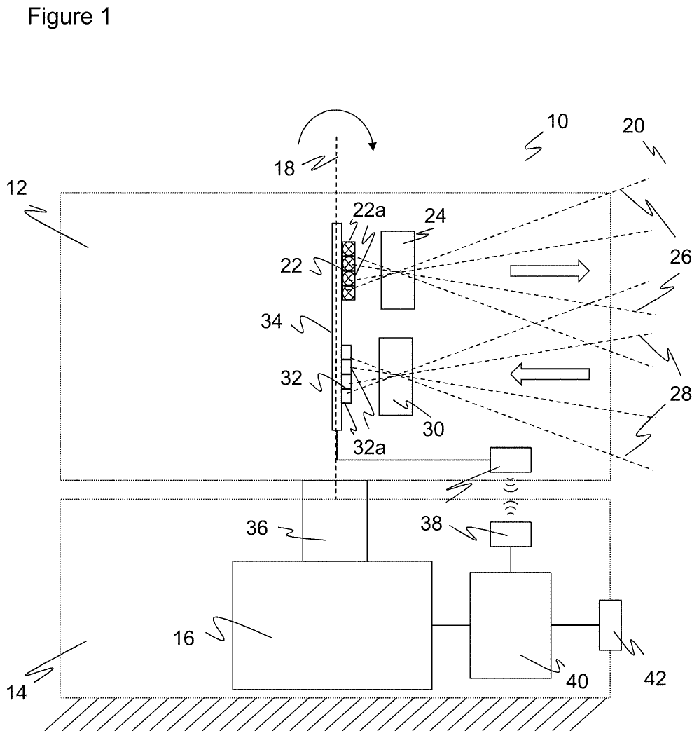

FIG. 1 a schematic sectional representation of an optoelectronic sensor configured as a laser scanner;

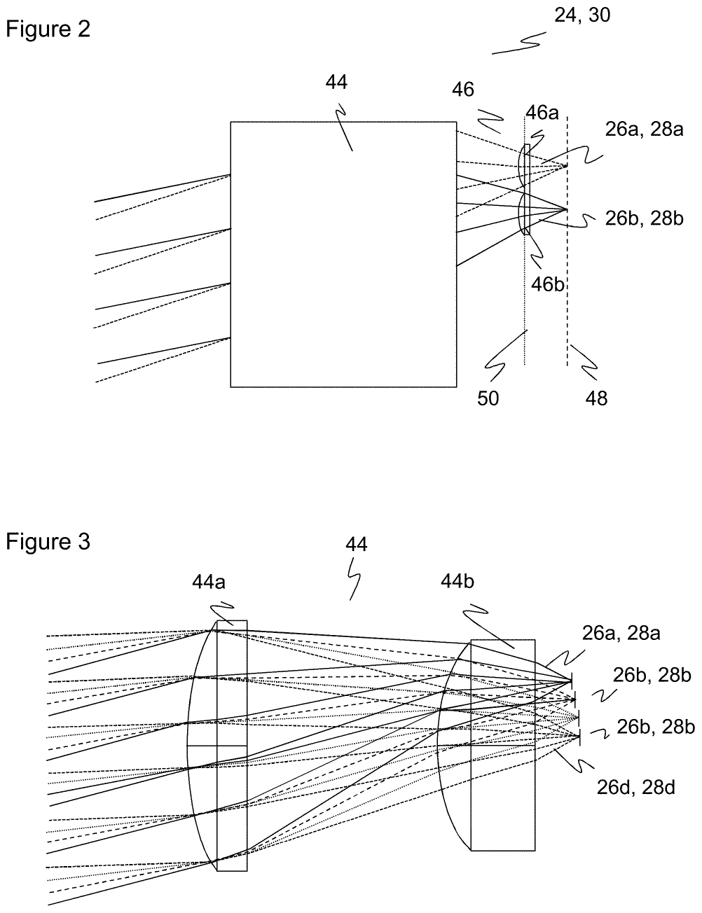

FIG. 2 a schematic overview representation of a reception optics and of the beam extents therein;

FIG. 3 a representation of the beam extents in a first optical system of the reception optics;

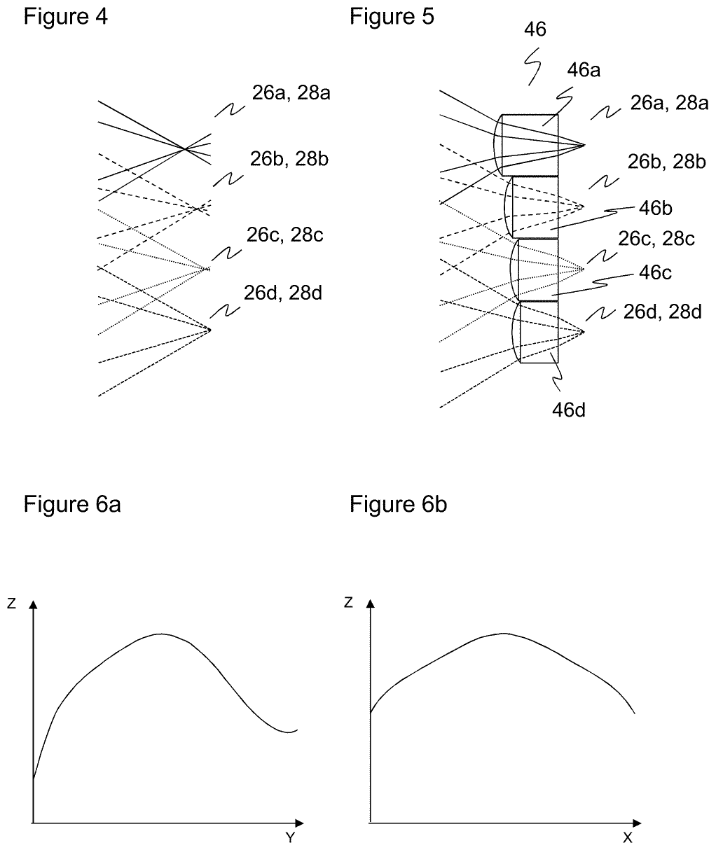

FIG. 4 an enlarged view of the beam extents in accordance with FIG. 3 in an environment of the imaging plane;

FIG. 5 a view similar to FIG. 4, but now with additional correction lenses of a second optical system of the reception optics; and

FIG. 6a a with the correcting second optical system.

FIG. 1 shows a schematic sectional representation through an optoelectronic sensor 10 in an embodiment as a laser scanner. The sensor 10 comprises a movable scanning unit 12 and a base unit 14 in a rough distribution. The scanning unit 12 is the optical measurement head, whereas further elements such as a supply, evaluation electronics, terminals and the like are accommodated in the base unit 14. In operation, the scanning unit 12 is set into a rotational movement about an axis of rotation 18 with the aid of a drive 16 of the base unit 14 to thus periodically scan a monitored zone 20.

In the scanning unit 12, a light transmitter 22 having a plurality of light sources 22a, for example LEDs or lasers in the form of edge emitters or VCSELs, with the aid of a transmission optics 24 generates a plurality of transmission light beams 26 having a mutual angular offset that are transmitted into the monitored zone 20. In the embodiment shown, there are four transmission light beams 26, but this number is not fixed and the invention is not limited thereto. In addition, it is conceivable that there are fewer light sources 22a than there are transmission light beams 26 or even that there is only one single light source by arranging at least one beam-splitting or pattern-generating element downstream of the light sources 22a or of the light source.

If the transmission light beams 26 are incident on an object in the monitored zone 20, corresponding remitted light beams return as reception light beams 28 to the sensor 10. The reception light beams 28 are guided by a reception optics 30 to a light receiver 32 having a plurality of light reception elements 32a that each generate an electrical reception signal. The light reception elements 32a can be separate components or pixels of an integrated matrix arrangement, for example, photodiodes, APDs (avalanche diodes), SPADs (single-photon avalanche diodes), or SiPM (silicon photomultiplier).

In the embodiment shown in FIG. 1, the light transmitter 22 and the light receiver 32 are jointly arranged on a circuit board 34 that lies on the axis of rotation 18 and that is connected to the shaft 36 of the drive 16. This can only be understood by way of example; practically any desired numbers and arrangements of circuit boards are conceivable. The basic optical design having a light transmitter 22 and a light receiver 32 biaxially disposed next to one another is also not compulsory and can be replaced by any construction shape known per se from single-beam optoelectronic sensors or laser scanners. A coaxial arrangement with or without a beam splitter is an example of this.

A contactless supply and data interface 38 connects the movable scanning unit 12 to the stationary base unit 14. A control and evaluation unit 40 is located there that can at least partly also be accommodated on the circuit board 34 or at another location in the scanning unit 12. The control and evaluation unit 40 controls the light transmitter 22 and receives the reception signals of the light receiver 32 for a further evaluation. It additionally controls the drive 16 and receives the signal of an angular measurement unit that is not shown, that is generally known from laser scanners, and that determines the respective angular position of the scanning unit 12.

For the evaluation, the distance from a sensed object is preferably measured using a time of flight method known per se. Together with the information on the angular position from the angular measurement unit, two-dimensional polar coordinates of all the object points in a scanning plane are available after every scanning period with angle and distance. The respective scanning plane is likewise known via the identity of the respective reception light beam 28 and its detection in one of the light reception elements 32a so that a three-dimensional spatial zone is scanned overall.

The object positions or object contours are thus known and can be output via a sensor interface 42. The sensor interface 42 or a further terminal, not shown, conversely serves as a parameterization interface. The sensor 10 can also be configured as a safety sensor for a use in safety technology for monitoring a hazard source such as a dangerous machine represents. In this respect, a protected field is monitored that may not be entered by operators during the operation of the machine. If the sensor 10 recognizes an unauthorized intrusion into the protected field, for instance a leg of an operator, it triggers an emergency stop of the machine. Sensors 10 used in safety technology have to work particularly reliably and must therefore satisfy high safety demands, for example the standard EN 13849 for safety of machinery and the machinery standard EN61496 for electrosensitive protective equipment (ESPE). The sensor interface 42 can then in particular be configured as a safe output device (OSSD, output signal switching device) to output a safety-directed switch-off signal on an intrusion of a protected field by an object.

The sensor 10 is protected by a housing, not shown, that has a transparent front screen in the passage zone for the transmission light beams 26 and the reception light beams 28. This front screen typically has the shape of a frustoconical jacket, of a cylindrical jacket, or somewhat more generally of a rotational body having a curved rather than a straight generatrix that can have a cup-shaped appearance, for example. Sections of a sphere or of an ellipsoid and very generally any suitable, complex 3D free-form shape are also possible.

During the rotation of the sensor 10, a respective surface is scanned by each of the transmission light beams 26. A plane of the monitored zone 20 is in this respect only scanned at a deflection angle of 0°, that is with a horizontal transmission light beam not present in FIG. 1. The remaining transmission light beams scan the jacket surface of a cone that is designed as differently acute depending on the deflection angle. With a plurality of transmission light beams 26 that are deflected upwardly and downwardly at different angles, a kind of nesting of a plurality of hourglasses arises as a scanned structure overall. These conical jacket surfaces are here also sometimes called scanning planes in simplified terms.

The sensor 10 shown is a laser scanner having a rotating measurement head, namely the scanning unit 12. In this respect, not only a transmission-reception module can rotate along as shown here, but further such modules having a height offset or an angular offset with respect to the axis of rotation 18 are conceivable. Alternatively, a periodic deflection by means of a rotating mirror or a facet mirror wheel is also conceivable. With a plurality of transmission light beams 26, it has to be taken into account in this respect that how the plurality of transmission light beams 26 are incident into the monitored zone 20 depends on the respective rotational position since their arrangement rotates through the rotating mirror as known geometrical considerations show. A further alternative embodiment pivots the scanning unit 12 to and fro, either instead of the rotational movement or additionally about a second axis perpendicular to the rotational movement, in order to also generate a scanning movement in elevation.

The embodiment as a laser scanner is also exemplary. Instead, a multi-scanner without a periodic movement is possible that then practically only comprises the stationary scanning unit 12 having corresponding electronics, but without a base unit 14.

FIG. 2 shows a schematic overview representation of the transmission optics 24 or reception optics 30 that is optimized in accordance with the invention for a discrete object field or image field, namely the mutually separated transmission light beams 26 and reception light beams 28 respectively. One such optics 24, 30 can be used at the transmission side or reception side or two such optics 24, 30 can be used at the transmission side and reception side. It is also possible to use one of the optics 24, 30 as a common transmission/reception optics, in particular in a coaxial arrangement of the sensor 10. In the following, the properties of the optics 24, 30 will be described, wherein usually no specific reference will be made to the use as a transmission optics 24 or as a reception optics 30.

The optics 24, 30 have a first optical system 44 and a second optical system 46 in a rough distribution. It must be noted that the reception path shown is represented mirrored to FIG. 1. The optics 24, 30 optimized in accordance with the invention utilizes the fact that only discretely arranged field points have to be imaged sharply. The field points are defined by the desired imaging of, for example, light sources 22a of the light transmitter 22 or in aperture openings of an aperture array, not shown, in the imaging plane 48 of the optics 24, 30. The beam bundles of the respective adjacent field points, that is the transmission light beams 28a-b or reception light beams 28a-b, are spatially separated from one another from a specific distance in front of the imaging plane 48. The region from which this decoupling has taken place, is disposed between a beam separation plane 50 and the imaging plane 48. Accordingly, in FIG. 2, the light beams 26a-b, 28a-b are mixed to the left of the beam separation plane 50 and are then separated to the right thereof.

Within the zone behind the beam separation plane 50, there is the possibility that the correction lenses 46a-b of the second optical system 46 can nominally image the beam bundle of a field point and thus an associated light beam 26a-b, 28a-b precisely to a point. So that this is possible, the beams of a beam bundle have to be able to be bijectively associated with a position in the entrance pupil of the respective correction lens 46a-b. This condition is satisfied by the aberrations image field curvature and astigmatism. Therefore, these aberrations can be compensated particularly efficiently by a correction lens 46a-b.

The correction lenses 46a-b are preferably disposed in a common correction lens plane in parallel with the imaging plane 48. To be able to keep the refractive power of the correction lenses 46a-b small, the distance from the imaging plane 48 should be as large as possible. On the other hand, the correction lens plane may not be disposed in front of the beam separation planes 50 since the beam bundles are otherwise not yet separated. Thus, the preferred position of the second optical system 46 and of its correction lenses 46a-b is particularly in the beam separation plane, as is also shown in FIG. 2. It is also advantageous in this connection to design the first optical system telecentrically at the image side.

In the design of the optics 24, 30, the first optical system 44 is preferably first optimized without a second optical system 46 and correction lenses 46a-b. In this respect, the optimization process is still carried out with all the field points. The back focal length is in this respect left variable for each field point within certain limits to be able to correct coma and spherical aberration as efficiently as possible. The variable back focal length corresponds to the not yet compensated image field curvature. The second optical system 46 is responsible for a correction of image field curvature and also astigmatism; its correction lenses 46a-b are then individually optimized in the next step. The optimization problem is decoupled since the beam bundles are separated. Only one respective surface is preferably optimized and the second surface remains planar.

The following surface shapes or height profiles can, for example, be used for the optimization:

$$s ( r , ρ , ϕ ) = \frac{c {r}^{2}}{1 + \sqrt{1 - ( 1 + k ) {c}^{2} {r}^{2}}} + {\sum }_{i = 1}^{N} {A}_{i} {Z}_{i} ( ρ , ϕ )$$

$$s ( r , x , y ) = \frac{{c}_{x} {r}^{2} + {c}_{y} {r}^{2}}{1 + \sqrt{1 - ( 1 + {k}_{x} ) {c}_{x}^{2} {r}^{2} - ( 1 + {k}_{y} ) {c}_{y}^{2} {r}^{2}}} + {\sum }_{i , j = 0}^{N} {A}_{i , j} {x}^{i} {y}^{j} .$$

The origin for describing the respective surface corresponds to the piercing point of the main beam, with respect to the optical main system of the respective beam bundle, through the planar surface of the correction lens. Zi designates the i-th Zernike polynomial (see “Zernike Standard Polynomials”: Noll, R. J. (1976). “Zernike polynomials and atmospheric turbulence”. J. Opt. Soc. Remark 66 (3): 207).

The parameters to be optimized are: c, k and Aᵢ or cₓ, c_{y}, kₓ, k_{y}, and A_{i,j}. In the following design example, four discrete field angles or transmission light beams 28a-d or reception light beams 28a-d are to be imaged with an exemplary angle in elevation of 2.25°/6.5°/10.75°/15° at an object distance in infinity. The sensor 10 is located in a housing having a front screen whose astigmatism can be corrected as well.

FIG. 3 shows an embodiment of the first optical system 44 that has two lenses 44a-b by way of example here. The object of the first optical system 44 arranged upstream is to correct coma, spherical aberration and, if necessary, chromatic aberration as well as possible. Coma and spherical aberration can only be compensated to a limited extent by the correction lenses 46a-b since they lead to an ambiguous association of a beam with a pupil coordinate in the case of highly pronounced errors, i.e. a plurality of beams can be associated with one pupil coordinate.

The two lenses 44a-b of the first optical system can be designed with a simplified radially symmetrical shape:

$$s ( r ) = \frac{c {r}^{2}}{1 + \sqrt{1 - ( 1 + k ) {c}^{2} {r}^{2}}} .$$

For example, the first lens 44a is a plano-convex asphere and the second lens 44b is a plano-convex sphere where k=0. As described above, during this optimization of the first optical system 44, the back focal length was left variable within specific limits for the individual field angles or transmission light beams 26a-d or reception light beams 28a-b in order to be able to correct the opening errors coma and spherical aberration as efficiently as possible. Accordingly, the positions of the light transmitter 22 or of the light receiver 32 indicated at the right-hand side of FIG. 3 are not yet disposed in a common plane.

FIG. 4 again shows this region in the environment of the imaging plane 48 and beam separation plane 50, which for the sake of clarity are not again drawn here, in enlarged form. It can clearly be recognized that the light beams 26a-d, 28a-d are bundled to different distances. An array of light sources 22a or an aperture array or a light receiver 32 without a curvature could here only be arranged in a position in which at least one light beam 26a-d, 28a-d has an enlarged beam cross-section.

FIG. 5 now shows this environment with the correction lenses 46a-d of the second optical system 46 that are individually optimized for each field angle. Image field curvature and astigmatism are now corrected. The light beams 26a-d, 28a-d are practically bundled to one picture element in a common plane. Accordingly, light sources 22a or light source points are imaged particularly sharply after a beam splitting and an aperture having particularly small aperture openings can in particular be arranged at the reception side here or, in an embodiment without an aperture, sharp reception light spots are produced on the light receiver 32.

Since all the correction lenses 46a-d can be arranged in one plane, there is the possibility of combining them in one functional element. The second optical system 46 can then be manufactured as a comparatively cheap and light injection-molded plastic part having a plurality of different optical functional surfaces that are each associated with a field point.

FIGS. 6a-b show an exemplary contour extent of a correction lens 46a in a section in the meridional plane designated by Y or in the sagittal plane designated by X. The Z direction designates the height of the contour extent. The scale in the Z direction is larger than in the X and Y direction in order to make the curvature more clearly visible. The height profile is typically not rotationally symmetrical, in particular in the meridional plane. It must be remembered that the correction lenses 46a are individually optimized and the contour therefore cannot apply for all the correction lenses 46a-d. However, the qualitative, non-rotationally symmetrical contour extent can be transferred depending on specific conditions.

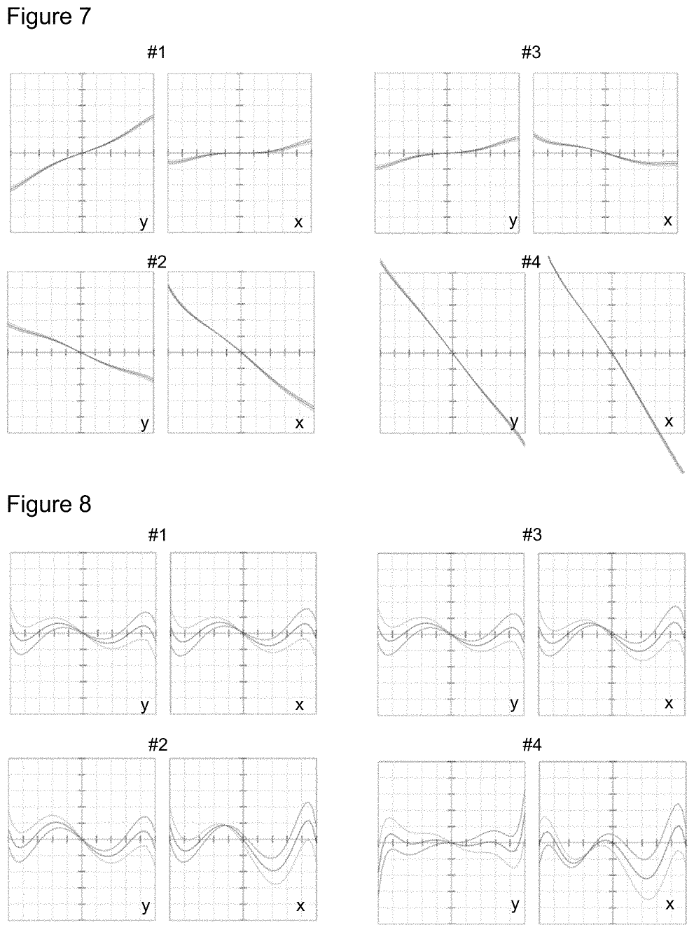

FIG. 7 shows ray fan plots for the four light beams 26a-d, 28a-d at the light transmitter position respectively aperture position or light receiver position first for a comparison in a situation without the correction lenses 46a-d, that is solely with the first optical system 44. The remaining residual errors after the optimization of the first optical system 44 are the astigmatism, in particular of the front screen, and the image field curvature.

FIG. 8 shows corresponding ray fan plots for the four light beams 26a-d, 28a-d, now in a situation with a second optical system 46 and its optimized correction lenses 46a-d. It must be noted that the ordinate is scaled finer than in FIG. 7 by a factor of ten. The residual errors are smaller by more than one order of magnitude. Only the chromatic aberration is not reduced further since, due to its principle, it cannot be taken up by the correction lenses 46a-d. The thermal influence of the functional surfaces is marginal since the refractive powers of the correction lenses 46a-d are low.

The absence of astigmatic error components shows the efficient correction of the optical influence of the front screen. This is due to the above-described bijective imaging property of the correction lenses 46a-d. If, for example, the astigmatism of the front screen is instead performed by a biconical lens, this bijectivity is no longer present since a point on the contour of the lens here has to correct the direction of beams of a plurality of field angles. The optimization problem is then overdetermined. The astigmatism of the front screen is consequently not only corrected by the second optical system 46 practically without any additional effort, but also very precisely.

1. An optoelectronic sensor for detecting objects in a monitored zone, the optoelectronic sensor comprising:
at least one light transmitter for transmitting a plurality of mutually separated light beams,
a transmission optics for the transmitted light beams,
at least one light receiver for generating a respective reception signal from light beams remitted by objects,
a reception optics for the remitted light beams, and
a control and evaluation unit for obtaining information on the objects from the reception signals,
wherein at least one of the transmission optics and the reception optics has a first optical system, wherein at least one of the transmission optics and the reception optics has a second optical system for correcting aberrations comprising a plurality of optical correction elements that are each associated with a light beam; and wherein the second optical system is arranged between a beam separation plane, from which the light beams do not mutually overlap due to an optical effect of the first optical system, and the light transmitter and/or the light receiver.

2. The optoelectronic sensor in accordance with claim 1,
wherein the light beams are arranged in one plane.

3. The optoelectronic sensor in accordance with claim 1,
wherein the first optical system has at least one common lens, and/or wherein the first optical system has two lenses.

4. The optoelectronic sensor in accordance with claim 1,
wherein the first optical system has two lenses with one lens being a spherical lens and the other lens being an aspherical lens.

5. The optoelectronic sensor in accordance with claim 1,
wherein the first optical system is optimized for a correction of coma and/or spherical aberration and the optimization allows a variation in the back focal length for an improved correction of coma and/or spherical aberration.

6. The optoelectronic sensor in accordance with claim 1,
wherein the optical correction elements of the second optical system are configured as correction lenses.

7. The optoelectronic sensor in accordance with claim 1,
wherein the optical correction elements have optical properties that are different from one another.

8. The optoelectronic sensor in accordance with claim 1,
wherein the optical correction elements are individually optimized for the respective associated light beam.

9. The optoelectronic sensor in accordance with claim 1,
wherein the optical correction elements are arranged in a common correction plane.

10. The optoelectronic sensor in accordance with claim 1,
wherein the optical correction elements are arranged in a common correction plane in parallel with the beam separation plane.

11. The optoelectronic sensor in accordance with claim 1,
wherein the second optical system is configured as a common component of the optical correction elements.

12. The optoelectronic sensor in accordance with claim 1,
wherein the optical correction elements have a free-form surface.

13. The optoelectronic sensor in accordance with claim 1,
wherein the second optical system is configured for a correction of image field curvature and/or of astigmatism.

14. The optoelectronic sensor in accordance with claim 1,
that has a curved front screen, and wherein the second optical system is additionally configured for a correction of distortions of the front screen.

15. The optoelectronic sensor in accordance with claim 14,
wherein the second optical system is configured for a correction of astigmatism of the front screen.

16. The optoelectronic sensor in accordance with claim 1,
wherein an aperture having a respective aperture opening per remitted light beam is arranged between the second optical system and the light receiver.

17. The optoelectronic sensor in accordance with claim 1,
that is configured as a laser scanner and that has a movable deflection unit with whose aid the transmitted light beams are periodically guided through the monitored zone.

18. The optoelectronic sensor in accordance with claim 17,
wherein the deflection unit is configured in the form of a rotatable scanning unit in which the light transmitter and/or the light receiver is/are accommodated.

19. The optoelectronic sensor in accordance with claim 1,
wherein the evaluation unit is configured to determine a distance of the objects from a time of flight between the transmission of the light beams and the reception of the remitted light beams.

20. A method of detecting objects in a monitored zone in which a plurality of mutually separated light beams are transmitted by a light transmitter through a transmission optics, a respective reception signal is generated in a light receiver from the light beams reflected by objects after a passing through of a reception optics, and the reception signals are evaluated to obtain information on the objects, wherein the transmission optics and/or the reception optics has/have a first optical system, wherein the light beams pass through the first optical system and a respective one of a plurality of optical correction elements of a second optical system for correcting aberrations, with the second optical system being arranged between a beam separation plane, from which the light beams do not mutually overlap due to the optical effect of the first optical system, and the light transmitter and/or the light receiver.
